(19) United States
(12) Patent Application Publication
(10) Pub. No.: US 2005/0043030 A1
(43) Pub. Date: Feb. 24, 2005

(54) Wireless communications system

(76) Inventors: Mojtaba Shariat, Colts Neck, NJ (US); Xue Qiang Yan, PuDong Shanghai (CN)

Correspondence Address: DUANE MORRIS, LLP;IP DEPARTMENT, ONE LIBERTY PLACE, PHILADELPHIA, PA, 19103-7396, US

(21) Appl. No.: 10/646,596

(22) Filed: Aug. 22, 2003

(51) Int. Cl. H04Q 7/00

(52) U.S. Cl. 455/449

(57) ABSTRACT

A communications system has, a base station (40) and an inter-working gateway (48) for operating two-way wireless Internet communications over a Universal Mobile Telecommunications System (UMTS) communications network. The Internet communications are segmented and multiplexed into framing protocol-protocol data units (FP-PDUs) to operate over the UMTS communications network.

### FIELD OF THE INVENTION

The present invention relates to a wireless communications system, and more particularly, to a third generation (3G) communications system that operates on the Universal Mobile Telecommunications System (UMTS) for cellular telephone communications.

### BACKGROUND OF THE INVENTION

An industry-wide collaborative group, the Third Generation Partnership Project, (3GPP) and (3GPP2), has established and published an industry-wide, standard-specification for a 3G communications system and hardware/software for the Universal Mobile Telecommunications System (UMTS). The UMTS has become adopted and implemented throughout Europe and elsewhere.

User equipment, for example, cellular telephones, must operate with UMTS protocol-formatting as a prerequisite for them to access a Base Transceiver Station (BTS) of the UMTS. Internet protocols are not recognized by the UMTS as a standard communication between these network elements. A BTS that communicates by Internet formatted communications is unable to access a Radio Network Controller of the UMTS for cellular telephone communications.

### SUMMARY OF THE INVENTION

According to the present invention, wireless Internet formatted communications in an indoor environment access a base transceiver station that segments the Internet formatted communications into Internet framing protocol-protocol data units (FP-PDUs). The base transceiver station multiplexes the FP-PDUs for operating over a UMTS communications network for cellular telephone communications.

For example, an interior space of an office building, is densely populated with users of wireless services. The present invention advantageously provides users of existing cellular telephones and other users with wireless access to a Pico Node B base transceiver station that is adapted for two-way wireless communications over the Universal Mobile Telecommunications System for cellular telephone communications.

According to an embodiment of the present invention, a Pico base transceiver station, a.k.a., Pico Node B, exchanges two-way wireless communications formatted with Internet protocols, and is adapted to operate in a communications system that is in compliance with the Universal Mobile Telecommunications System.

According to another embodiment of the present invention, a UMTS communications system is adapted with, a UMTS base transceiver station to manage two-way wireless communications formatted with UMTS protocols, and the UMTS communications system is adapted with a Pico Node B base transceiver station to manage two-way wireless communications formatted with Internet protocols.

Another embodiment of the invention is a method for wireless Internet communications to operate over a communications system for wireless telephone communications. The method includes the method steps of, segmenting the communications into Internet framing protocol-protocol data units (FP-PDUs); multiplexing the FP-PDUs by multiple protocol label switching (MPLS) the FP-PDUs over separate label switched paths of an El link that is a physical layer interface in compliance with Internet El physical layer transport protocol; and exchanging the multiplexed FP-PDUs as formatted multiplexed MPLS data segments by a Radio Network Controller in a UMTS communications system. Thus, the Internet communications operate as multiplexed data units over the UMTS communications system.

According to a further embodiment of a method according to the invention, segmenting data traffic into FP-PDUs of 350 octets maximum length is necessary when the data rate exceeds 64 kbps, to prevent blocking impediment of voice traffic FP-PDUs by long duration data transmissions.

MPLS LSPs, which are MPLS label switched paths, serve to segregate the FP-PDUs, without a need to convey Layer 3 network layer/Layer 4 transport layer information (L3/L4 information) in each MPLS frame when the MPLS-LSPs have been established by the L3/L4 information. The invention eliminates a need to append a sequence number in the stream overhead of the segmented FP PDUs, when the in-delivery-delivery sequence is provided by the order of the label-switched FP-PDUs in the MPLS-LSPs.

### BRIEF DESCRIPTION OF THE DRAWINGS

FIG. 1 is a diagram of a UMTS protocol communications system for managing two-way wireless communications.

FIG. 2 is a diagram of communications system for a UTRAN element of the UMTS protocol communications system disclosed by FIG. 1.

FIG. 3 is a diagram of UMTS protocols installed in a Node-B element of the UTRAN element disclosed by FIG. 2.

FIG. 4 is a diagram of an Internet protocol communications system for managing two-way wireless communications formatted with Internet protocols.

FIG. 5 is a diagram of protocols installed in an inter-working gateway, an element of the communications system disclosed by FIG. 4.

FIG. 6 is a diagram of protocols installed in an embodiment of a Pico Node-B , an element of the communications system disclosed by FIG. 4.

FIG. 7 is a diagram of a baseband and network interface card, BNI card, an element of the communications system disclosed by FIG. 4.

FIG. 8 is a diagram of a process for processing packet-based data units by multi-protocol label switching, MPLS, using the BNI card disclosed by FIG. 7.

FIG. 9 is a diagram of multiplexed data units of voice streams according to operation of a multiplexer, MUX, an element of the BNI card disclosed by FIG. 7.

FIG. 10 is a diagram of segmented data units of data information streams according to operation of a segmenter, SEG, an element of the BNI card disclosed by FIG. 7.

FIG. 11 is a graph comparing transport efficiencies of voice service and data service provided by a UMTS protocol communications system disclosed by FIG. 2, compared with corresponding transport efficiencies provided by an MPLS process disclosed by FIG. 8.

FIG. 12 is a graph of the transport efficiency of data service for up to 40 users, as provided by a UMTS protocol communications system disclosed by FIG. 2, compared with the transport efficiency of data service as provided by an MPLS process disclosed by FIG. 8.

FIG. 13 is a graph, similar to the graph disclosed by FIG. 12, of the corresponding transport efficiencies of data service for fifty users and more.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

An industry-wide collaborative group, the Third Generation Partnership Project, (3GPP) and (3GPP2), has established and published an industry-wide, standard-specification for a third-generation, 3G communications system and hardware/software for the Universal Mobile Telecommunications System, UMTS. The following description will frequently refer to the standard-specification.

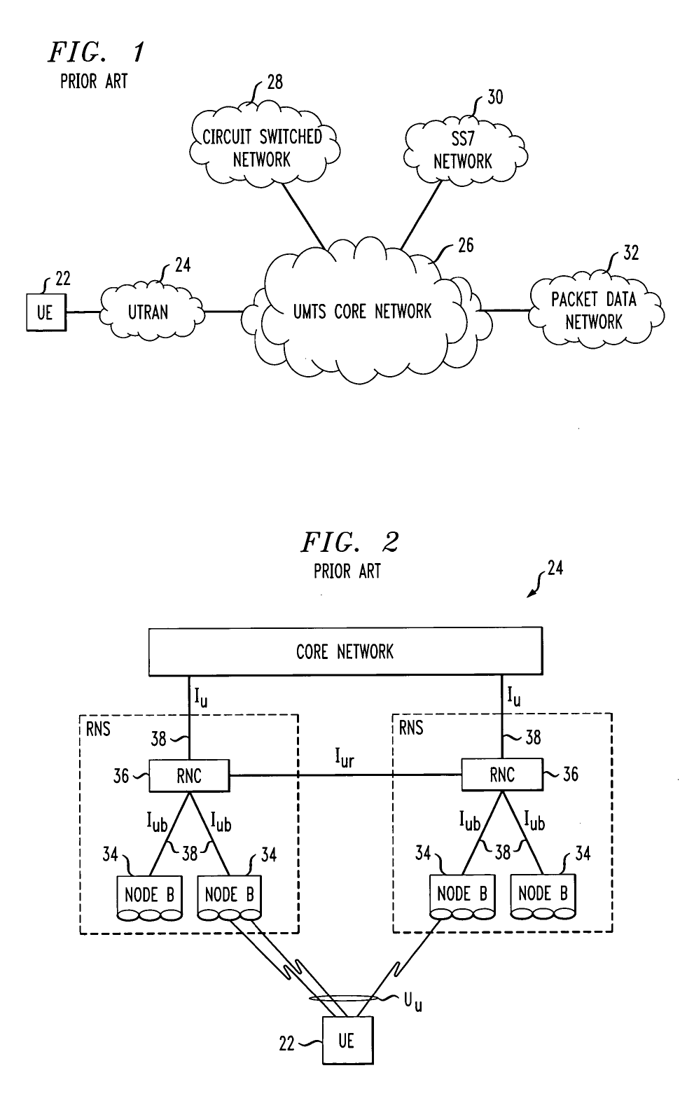

FIG. 1 discloses a UMTS protocol communications system that conforms to the standard-specification. The UMTS protocol communications system comprises, the following elements, a core network, CN, 26 interconnected with a universal terrestrial radio access network, UTRAN, 24 by way of a standard-specification interface Iu (disclosed by FIG. 2). With continued reference to FIG. 1, the core network, CN, 26 interconnects with additional elements that comprise, a circuit switched network 28, an SS7 network 30 and a packet data network 32. Wireless user equipment 22, for example, a cellular telephone, exchanges two-way wireless communications that interface, via atmospheric air, with the UTRAN 24. The user equipment 22 comprises any one of various de voices that provide a user with two-way wireless communications with the Universal Mobile Telecommunications System, UMTS.

FIG. 2 discloses the communications system of the universal terrestrial radio access network, UTRAN 24. With reference to FIG. 2, the core network 26 interconnects with the communications system of the UTRAN, 24. The UTRAN 24 manages two-way wireless transmissions of voice, data and other wireless services. Wireless communications that access the UTRAN 24 are given flexible bandwidth on demand. FIG. 2 further discloses that the user equipment 22 establishes interconnection, through atmospheric air, to the UTRAN 24. Atmospheric air comprises a specification-standard interface Uu, as an element of the communications system of the UTRAN 24. A further element of the UTRAN 24 comprises, a corresponding one or more Node-Bs 34. Each Node-B 34 is synonymous with the terminology, base station, or alternatively, base transceiver station, BTS. Each Node-B 34 interfaces with atmospheric air. In turn, the UTRAN 24 is an element of the UMTS protocol communications system disclosed by FIGS. 1 and 2.

With continued reference to FIG. 2, each Node-B 34 interconnects, by way of a standard-specification interface Iub, with a corresponding radio network controller, RNC, 36. The interface Iub establishes a corresponding physical layer connection 38 between a corresponding Node-B 34 and a corresponding RNC 36 . Each RNC 36 manages multiple Node-Bs 34. Each Iub conforms to standard-specification UMTS protocols that provide for separation of radio-controlled network functionality (protocols) and transport functionality (protocols).

With continued reference to FIG. 2, each RNC 36 is interconnected with another RNC 36 by way of a corresponding, standard-specification interface Iur. Further, each RNC 38 interconnects with the Core Network 26 by way of a corresponding, standard-specification interface Iu.

With continued reference to FIG. 2, the functionality of a Node-B 34 will now be described. Each Node-B 34 is associated with one or more cells thereof. For example, FIG. 2 discloses each Node-B 34 with three cells having ellipse shapes. Further, each Node-B 34 interfaces with the user equipment 22, and manages two-way wireless communications in one or more cells thereof. Specific management tasks, comprising radio-controlled network layer functionality and transport functionality, are performed by each Node B, according to the standard-specification. A commercially available, Node-B, known as OneBTSₜₘ, is supplied by Lucent Technologies Inc.

FIG. 3 discloses UMTS protocols operating in each Node-B 34. The protocols are in the form of data units that are installed and stored in a corresponding Node-B 34. FIG. 3 depicts the UMTS protocols in layers or stacks. The UMTS protocols comprise; sets of rules governing the format of voice/media, and governing the transport of traffic exchanged between the elements of the UMTS protocol communications system. With further reference to FIG. 3, two-way wireless communications are exchanged between user equipment, UE, 22 and a corresponding Node-B 34. The communications are formatted with the UMTS protocols.

With continued reference to FIG. 3, communication exchanges between each Node-B 34 and a corresponding radio network controller, RNC, 36, are formatted with the physical layer protocol, i.e., the E1 protocol, and the asynchronous transfer mode protocol, i.e., the ATM protocol, which protocols operate with the transport and exchange of two-way communications with the RNC 36 . Further, the communication exchanges with the RNC 36 are formatted with the remainder of the formats, as disclosed in FIG. 3, and referred to collectively as radio-controlled network layer protocols, i.e., the RNL protocols, which are movable from the transport functionality protocols E1 and ATM. Accordingly, each Node B 34 and a corresponding radio network controller, RNC, 36 are interconnected over a corresponding interface Iub, with two-way communications formatted with the E1 protocol and the ATM protocol, for transport and exchange with the RNC 36 . Further, the two-way communications are formatted with the RNL protocol.

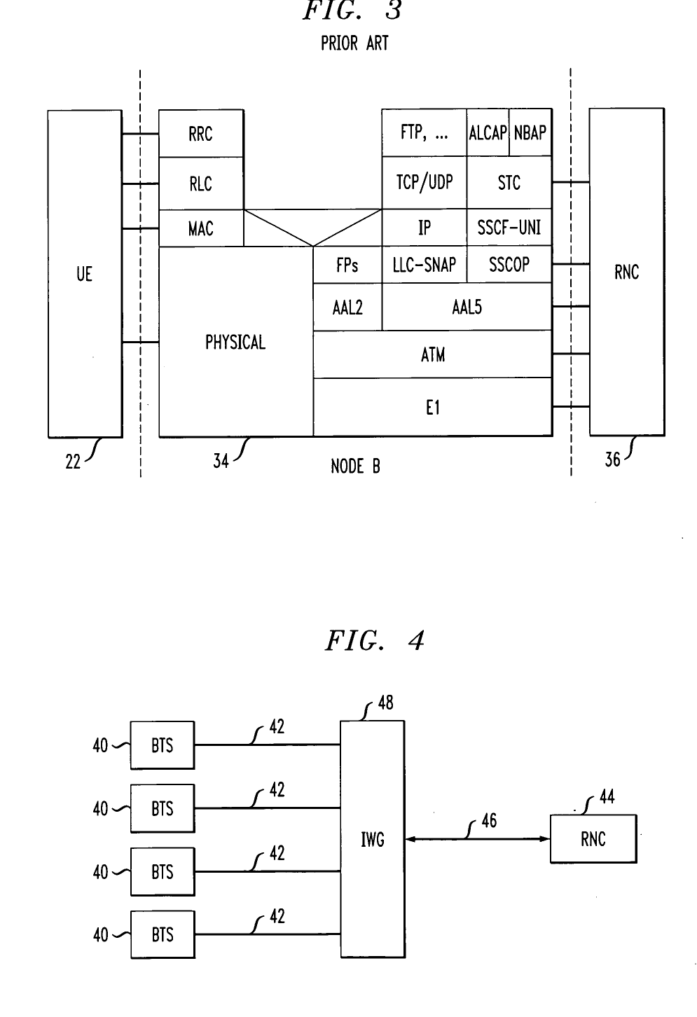

With reference to FIG. 4, an embodiment of the present invention will now be described. FIG. 4 discloses an Internet protocol communications system operating with Internet protocols, IP. However, the Internet protocols do not comprise protocols of the standard-specification for the Universal Mobile Telecommunications System, UMTS. Accordingly, the UMTS communications system, as disclosed by FIGS. 1 and 2, is unable to manage two-way wireless communications formatted with Internet protocols. For example, the two-way wireless communications are formatted by an Internet browser for access to the Internet.

The present invention provides apparatus and a method by which the UMTS protocol communications system, as disclosed by FIGS. 1 and 2, is adapted with the Internet protocol communications system, as disclosed by FIG. 4, which enables the UMTS protocol communications system to manage two-way wireless communications formatted with Internet protocols.

With continued reference to FIG. 4, the Internet protocol communications system comprises, one or more Pico Node-B base stations 40. Each Pico Node-B base station 40 comprises a base transceiver station operating with Internet protocols, and wirelessly transmitting and receiving voice and data communications that are formatted with Internet protocols. Previous to the present invention, the two-way wireless communications were restricted to being transmitted over The Internet.

With continued reference to FIG. 4, another element of the Internet protocol communications system comprises an inter-working gateway, IWG 48. Each Pico Node-B base station 40 has a physical layer interconnection 42 with Internet protocols for communicating with the IWG 48. As disclosed by FIG. 4, each Node-B base station 40 is interconnected in a local area network, LAN. For example, the LAN comprises a STAR LAN in which each of the Pico Node-B base station 40 is wired in a star configuration from a central hub of the LAN. The IWG 48 comprises the central hub, or alternatively, is itself wired in a star configuration from a central hub of the LAN. The communications system comprises a LAN of any configuration, including, and not limited to, a STAR LAN and a Token Ring LAN.

The IWG 48 connects at the physical layer with the Internet protocol, Ethernet 10/100 Base-T interface 42 with each Pico Node-B base station 40. However, the Internet protocols do not comprise a protocol of the Universal Mobile Telecommunications System, UMTS. Further, the Pico Node-B base station 40 and the Ethernet 10/100 Base-T interface 42 are not elements of the Universal Mobile Telecommunications system, UMTS. However, according to the present invention, the Internet protocol communications system, as disclosed by FIG. 4, is adapted for interconnection with the UMTS protocol communications system disclosed by FIGS. 1 and 2, which enables two-way wireless communications, formatted with Internet protocols, to operate over the Universal Mobile Telecommunications System, UMTS.

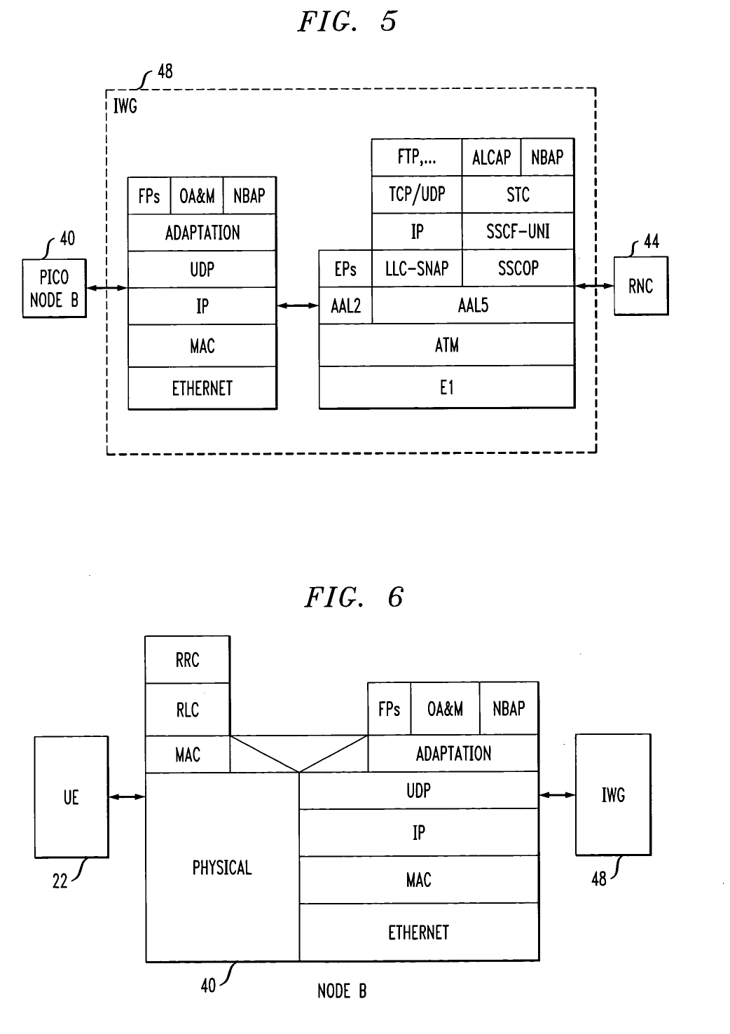

FIG. 5 discloses a set of Internet protocols installed in the IWG 48. The Internet protocols comprise, FPs, OA&M, NBAP, Adaptation, UDP and IP, collectively referred to as movable Internet radio-controlled network layer protocols, , i.e., Internet RNL protocols,. Further, FIG. 5 discloses a transport protocol MAC and a physical layer protocol Ethernet, collectively referred to as comprising Internet transport protocols.

Further, FIG. 5 discloses a set of UMTS protocols installed in the IWG 48. The UMTS protocols comprise FTP, ALCAP, NBAP, TCP/UDP, STC, IP, SSCF-UNI, EPs, LLC-SNAP, SSCOP, AAL2 and AAL5, collectively referred to as moveable radio-controlled network layer protocols, i.e., UMTS, RNL protocols. Further, FIG. 5 discloses an ATM transport protocol over an E1 physical layer protocol, which are collectively referred to as comprising UMTS transport protocols. The protocols disclosed by FIG. 5 are in the form of stored data units, that are stored and implemented by the IWG 48 to perform protocol conversion, or reformatting, of protocol formatted, packet-based, voice and data communications for transport and exchange from the Pico Node-B base station 40 to the IWG 48, in a first direction, and to the IWG 48 from an RNC 46 , or, alternatively, an RNC 36 , in a second direction.

With continued reference to FIG. 5, The IWG 48 interfaces and communicates with a new, standard-specification RNC 46 , FIG. 4, or alternatively, with an existing standard-specification RNC 36 , FIG. 3, of an existing UMTS communications system, FIG. 2. The IWG 48 has a standard-specification T1 interface with UMTS protocols for interconnection and communication with the RNC 46 , or, alternatively, with the RNC 36 . Voice packets and data packets, comprising data units formatted with UMTS protocols, are transported by the RNC 46 , or alternately, the RNC 36 in the UMTS protocol communications system. The IWG 48 reformats both the voice packets and data packets with Internet protocols, upon exchange of the voice packets and data packets from the RNC 46 , or from the RNC 36 , to the IWG 48. Further, the E1 protocol, FIG. 3, and ATM protocol, FIG. 3, comprise the transport formatting of the voice packets and data packets for communication along the interface to and from the RNC 46 or, alternatively, to and from the RNC 36 , to the IWG 48. An exemplary IWG 48 comprises a model PMC 4539 communications controller supplied by Interphase Corporation, Dallas. Texas, which provides four T1/E1 interfaces and one 10/100 Base-T Ethernet interface. Another exemplary IWG 48 comprises Motorola 8260 Communications processor Module supporting both ATM and Ethernet protocols.

With continued reference to FIG. 5, an operation of the IWG 48 will now be described. The IWG 48 separates and moves the moveable radio-controlled network layer protocols, i.e., the UMTS RNL protocols, from the transport protocols, E1 protocol and ATM protocol. The IWG 48 applies the moved RNL protocols in the transport layer of the Internet protocols layer or stack. The voice and data communications that intercept the Pico Node-B base station 40 comprise voice packets of data units and data packets of data units for further processing. Further the communications undergo format conversion, or reformatting, wherein the Pico Node-B base station 40 reformats the communications with the moved RNL protocols. Thus, the communications become reformatted with UMTS protocols, immediately as the communications begin transport from the Pico Node-B base station 40 in a direction toward the UMTS protocol communications system. Thereafter the communications remain reformatted with UMTS protocols for transport within the UMTS protocol communications system.

Similarly, the IWG 48 separates and moves the Internet RNL protocols from the Internet transport protocols, and applies the moved Internet RNL protocols in the ATM protocol transport layer, using the ATM transport protocol formatting. The voice packets for transport within the UMTS protocol communications system, become reformatted with Internet protocols by the IWG 48, immediately as they begin transport in a direction toward the Internet protocol communications system, i.e., the IWG 48 and the Pico Node-B base station 40. Thereafter, the voice packets and the data packets remain reformatted with Internet protocols for transport within the IWG 48, the Pico Node-B base station 40, and for wireless transmission from the Pico Node-B base station 40 for reception by the user equipment.

Thus, according to a further embodiment of the present invention, a process of performing communications system adaptation comprises, interconnecting a Pico Node-B base station 40, by an Ethernet 10 Base-T interconnection 42 to an RNC 46 , or alternatively, to an RNC 36 , by way of an interworking gateway, IWG, 48, moving data units of radio-controlled network protocols from the protocol data units, E1 protocol and ATM protocol, and installing the data units of radio-controlled network protocols, and reformatting and exchanging communication data units formatted with Internet protocols, between the Pico Node-B base station 40 and the RNC 46 .

With continued reference to FIG. 5, the protocols that are implemented by the IWG 48, comprise, in part, the E1 and the ATM protocols of the UMTS protocols, which are identical in, both the Node-B 34 of the embodiment disclosed by FIGS. 3, and the IWG 48 disclosed by FIG. 5. The E1 protocol and the ATM protocol, of the embodiment disclosed by FIG. 5, adapts each Pico Node-B base station 40 and the IWG 48 for interconnection to the RNC 36 , FIG. 3, of an existing UMTS communications system, as disclosed by FIG. 2. Accordingly, the UMTS protocol communications system becomes adapted with an Internet protocol communications system to enable two-way wireless communications formatted with Internet protocols.

The UMTS protocol communications system, disclosed by FIG. 2, that is adapted with the IWG implemented protocols, as disclosed by FIG. 5, is adapted with both an existing Node-B 34 type of UMTS protocol communications system, as well as, a Pico Node-B base station 40 of an Internet protocol communications system, which enables management of two-way wireless communications that are formatted in either a UMTS protocols format or an Internet protocols format.

According to an embodiment of the present invention, the IWG 48 is supplied as already installed with the protocols disclosed by FIG. 5, which avoids further installation of such protocols from another source.

According to an alternative embodiment of the present invention, the IWG 48 is supplied without the protocols disclosed by FIG. 5. More specifically, the Pico Node-B base station 40 has computer software installed that transports the protocols, disclosed by FIG. 5, to the IWG 48, thus, installing the protocols in the IWG 48, or, alternatively, updating the software previously installed in the IWG 48. The IWG 48 is adapted to receive the installation by having the Ethernet transport protocol installed, and ready to receive installation of further protocols. For example, a Node-B apparatus, known as OneBTSₜₘ, commercially available from Lucent Technologies Inc., is manufactured in the form of a Pico Node-B base station 40 prior to shipment to an installation site. An advantage is that the latest versions of Internet protocols and UMTS protocols are installed in the Pico Node-B base station 40 prior to shipment to an installation site. At the installation site, the Pico Node-B base station 40 is interconnected at the physical layer interconnection 42 disclosed by FIG. 4, to a corresponding IWG 48, or, alternatively, to an existing IWG 36 already installed at the installation site. Alternatively, according to the present invention, the Pico Node-B base station 40 and the IWG 48 are interconnected with an existing RNC 36 of a UMTS protocol communications system existing at an installed site. Subsequently, the latest version of the protocols, as shown in FIG. 5, are transported, over the interconnection 42 disclosed by FIG. 4, to install in the IWG 48, or, alternatively, to install in the IWG 36.

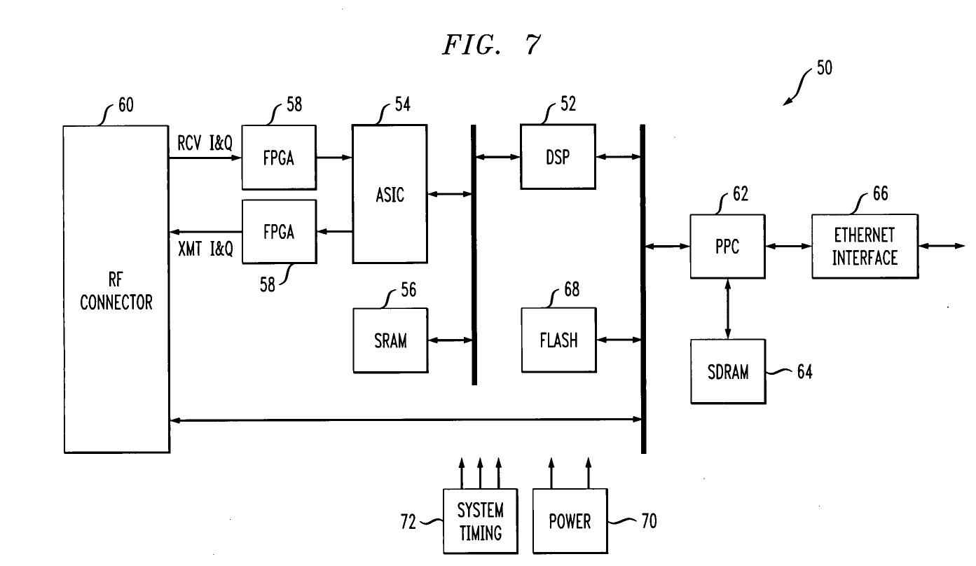

FIG. 6 discloses Internet protocols, IP, and a set of RNL protocols, which are implemented by the Pico Node-B base station 40. More specifically, each Pico Node-B base station 40 is disclosed in FIG. 6, as having an installed set of Internet protocols to manage two-way wireless communications that are formatted with Internet protocols, and further, that are exchanged with user equipment 22. After the Pico Node-B base station 40 and an associated IWG 48 are installed at an installation site, the base station 40 segments and reassembles the protocols into a user datagram protocol payload, i.e., a UDP payload, for transport and installation in the IWG 48. There are two cases to consider when assigning the UDP ports in the physical layer to receive transport of the UDP payload.

Case 1, for a single Pico Node-B base station 40, each of the IWG 48 and the BTS 40 has one IP protocol address within the same arbitrary subnet. Each ATM protocol virtual channel, VC, within the virtual path is mapped to a unique user datagram protocol port, UDP port. For example, the Node-B application part message that is assigned to the VCI number “X” is mapped into the UDP port address of “Y”. The Node-B application part is assigned to a single VC with AAL5 formatting. Only one virtual path interconnection for all channels is defined as being based on the permanent virtual circuit connection. A single E1 physical layer interface is capable of supporting 1920 Kbps of user data, which is equivalent to 30 channels of 64 Kbps service. The user traffic, which includes, voice and data services (AMR plus Data) is mapped into a single VC with AAL2 formatting. The operations, administration and maintenance messages, OA&M, are transmitted using a single VC with AAL5 formatting. The RNC 36 or 44 is in control of assigning, establishing and releasing traffic channels. The mapping table is updated with this information.

Case 2, for multiple cells in a Pico Node-B base station 40, the IWG 48 is connected to the multiple cells. which all appear to the RNC 48 as a single node. The ATM Internet protocol mapping table sorts out and distinguishes the cells from one another, based on the traffic assigned to the cells. The IWG 48 has the IP address of each Pico Node-B base station 40. The mapping table traces between the UDP ports associated with each IP address and a subset of ATM protocol VCs. The RNC 48 controls how the VCs are assigned to users, and depends upon the parameters of the traffic, i.e. incoming or outgoing, voice or data, and to or from a mobile unit that needs handing off among cells and Pico Node-B base stations 40, to correspond with geography changes by the user equipment 22.

With reference to FIG. 7, an embodiment of the invention comprising, the communications system of the Pico Node-B base station 40 will be described. The base station 40 comprises a single sector/single carrier supporting up to two channel elements. The base station 40 comprises two circuit boards, a baseband & network interface card, BNI card 50, and an Analog & RF, radio frequency, mezzanine card 60 that is installed on the BNI card 50, for example, as a daughter card or as a mezzanine card. The mezzanine card 60 provides analog and radio frequency transmission of communications, and has a physical layer interconnection with the card 50 and has external RF coaxial connectors, not shown. The coaxial connectors enable physical layer connection of the card 60 with known coaxial cables. Further, the base station 40 is connected at the physical layer to a power cable supplying 48 Volts, DC power, and is interconnected at the physical layer to the IWG 48 by way of a 10/100 Base-T Internet communications cable.

FIG. 7 discloses a BNI card 50 of a Pico Node-B base station 40. The BNI card 50 is a replacement printed circuit card for a UCU64 board that has been supplied in the commercially available, Node-B 34, known as OneBTSₜₘ, supplied by Lucent Technologies Inc. Thus, the present invention permits the OneBTSₜₘ, as supplied by Lucent Technologies Inc. to be supplied as either a Node-B base station 34, or a Pico Node-B base station 40, which extends the available products comprising base stations.

With further reference to FIG. 7, a baseband portion of the BNI card 50 comprises a channel element CE comprising, a digital signal processor, DSP, 52 integrated circuit, an associated flash memory 68, a Tipan 1.5 application specific integrated circuit, ASIC, 54 to manage baseband processing, and an SRAM memory 56. The DSP 52 comprises, for example, DSP model number 16410C available from Agere Systems, Allentown Penn.

The BNI card 50 has up to two channel elements CE, each of which processes up to eight voice communications or a single 384 Kbps data communication that is encoded and assigned and otherwise formatted, as RCV I&Q data and XMT I&Q data, by the field programmable gate array, FPGA 58 that interfaces with the analog and RF, radio frequency, mezzanine card 60.

The BNI card 50 has a microprocessor PPC 62, for example, model PPC 405G supplied by Motorola, Inc., Schaumberg, Illinois, accompanied by an SDRAM memory 64. The microprocessor PPC 62 configures each Channel element, CE, stores user data in the SDRAM memory 64, exchanges user data with the DSP 52, and processes the moveable protocols and the transport protocols at the Iub interface 46 of the IWG 48 and the RNC 46 , which protocols include the MAC protocol of the physical layer, Ethernet 10/100 Base-T interconnection of each Pico Node-B base station 40. The physical layer of the BNI card 50 has an interconnection with the Ethernet 10/100Base-T LAN interface 66, a cable connection with a DC power supply 70 and is connected with a clock circuit 72 for system timing.

According to an embodiment of the invention, the IWG 48 adapts the Internet protocol communications system with the UMTS protocols that are necessary for interconnection to an RNC 36 , FIG. 2, of a UMTS protocol communications system disclosed by FIGS. 1 and 2. Thus, the inter-working gateway, IWG, 48 operatively interconnects the Pico Node-B base station 40 that operates with Internet protocols, by way of the Iub interface 46, with the radio network controller, RNC, 36 operating with the UMTS protocols disclosed by FIG. 3.

According to another embodiment of the invention, the Pico Node-B base station 40 is adapted with the IWG 48 to interconnect with an RNC 36 of an existing, installed UMTS protocol communications system disclosed by FIGS. 1 and 2, which enables two-way wireless communications formatted with Internet protocols to operate over the UMTS protocol communications system. Thus, an Internet protocol Pico Node-B base station 40 is adapted with the IWG, 48 for interconnection with a Universal Mobile Telecommunications System, UMTS.

According to a further embodiment of the invention, a UMTS protocol communications system is adapted with the Pico Node-B base station 40 to manage two-way wireless communications, formatted with Internet protocols, over a UMTS protocol communications system.

With further reference to FIG. 4, The Iub interface, having the Internet protocols, is interconnected in the Internet protocol communications system by having a 10/100 Base-T Internet connection established by wire and cable assemblies conforming to the standard-specification for 10/100 Base-T type, local area network, wire-interconnected communications system. This architecture has an insignificant effect, if any, on the radio resource control layer, RRC layer. Instead, the standard-specification, protocols for the RCC layer, which are depicted by FIG. 3, will remain separate from the Internet protocols for each Pico Node-B base station 40. Advantageously, the Internet protocols, and the Internet communications system, as disclosed by FIG. 4, are separate and distinct from the Node-B protocols and associated Node-B communications system, as disclosed by FIGS. 2 and 3. Further, the terrestrial air interface technology of the Node-B 34 of the UMTS communications system is separate and distinct from the Time Division Duplex, TDD, terrestrial air interface technology of the Pico Node-B base station 40, as disclosed by FIG. 4, operating with Internet protocols.

The Internet protocol communications system, FIG. 4, operates by packet switching technology for managing data units of communications in packet format. Advantageously, the UMTS protocol communications system, FIG. 1, involves packet switching technology that is similar, which permits similar solutions to resolving maintenance issues. According to the present invention, packet switching is provided by the Packet Data Network 32 for managing data units of communications formatted with the ATM protocol disclosed by FIG. 3.

The Internet protocols comprise the standard two-way communications system for computer work stations having Internet browsers formatted with Internet protocols, which means that the present invention provides a system that is especially suited for indoor use, for example, in office buildings that are heavily populated with computer work stations seeking two way wireless communications. The present invention provides access to the UMTS for those work stations seeking two-way wireless communications with wireless cellular telephones by using an Internet browser and Internet protocol devices and software. Companies that provide their own maintenance service for their computer work stations already possess the capability to service Internet protocols maintenance issues, and may not possess the capability for resolving cellular telephone maintenance issues.

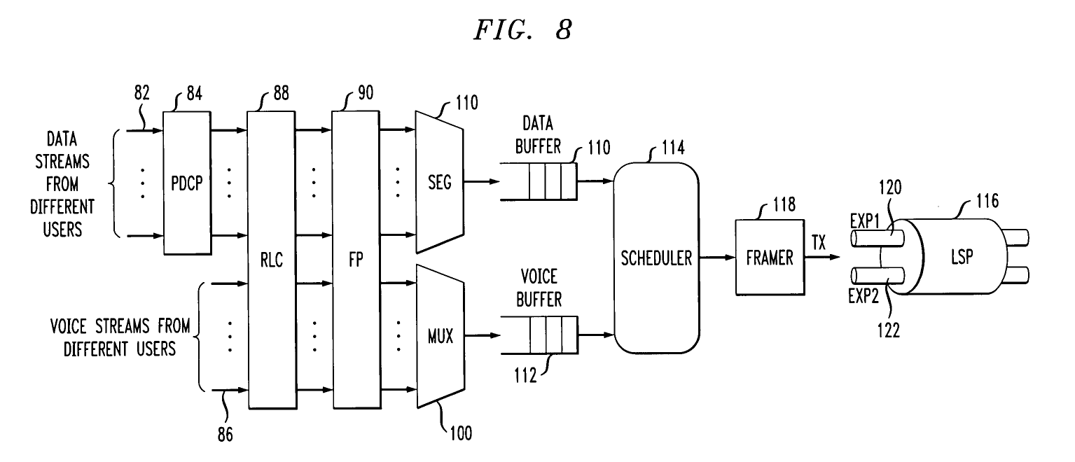

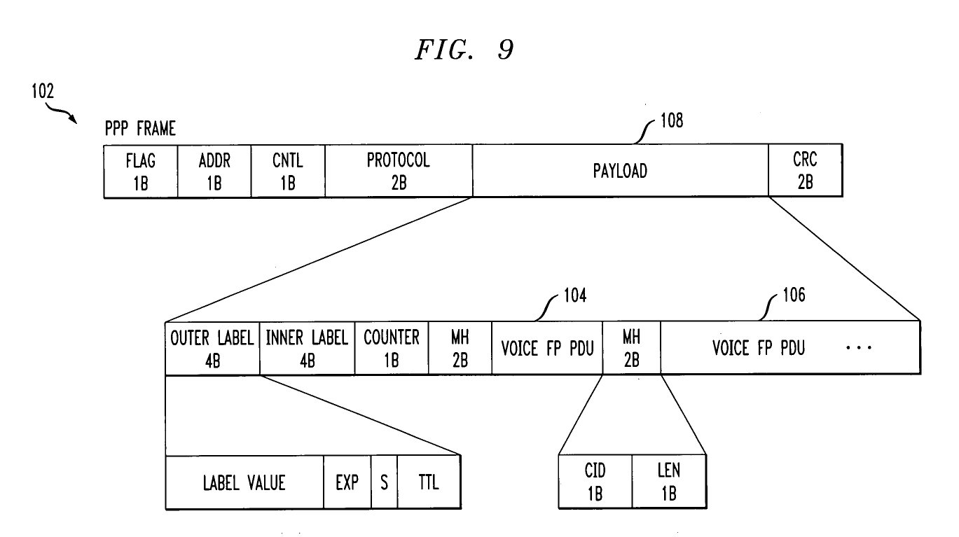

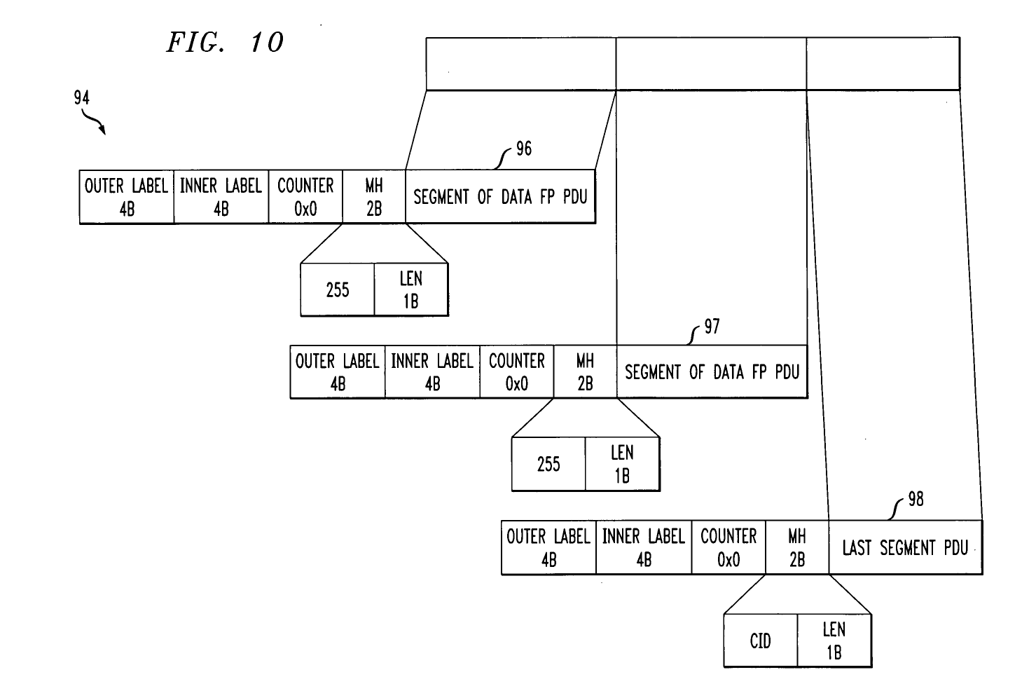

With reference to FIG. 8, the Figure discloses an embodiment that performs a method of processing Internet protocol formatted communications for access to a Radio Network Controller of the Universal Mobile Telecommunications System, UMTS. A multiple protocol label switching (MPLS)multiplex/segmentation method handles FP PDUs, which are Internet framing protocol (FP), protocol data units (PDUs), carried over an E1 link, a physical layer interface of Internet E1 physical layer transport protocol format. Segmentation of data traffic into PDUs of 350 octets maximum length is necessary when the data rate exceeds 64 kbps, to prevent blocking impediment of voice traffic PDUs by long duration data transmissions. MPLS LSPs, which are MPLS label switched paths (LSPs), serve to tunnel the PDUs, without a need to convey :L3/L4 information in each MPLS frame when the LSP has been established by the L3/L4 information. The invention eliminates a need to append a sequence number in the stream overhead of the segmented FP PDUs, for the in-delivery-delivery sequence is provided by the LSP. FIG. 8 further discloses a packet based data processing process, and data flow communications system, according to the present invention. FIG. 8 discloses data streams 82 from different users of user equipment 22 being intercepted, by the Pico Node-B bases station 40, FIG. 4, and formatted, by the ASIC 54 disclosed in FIG. 7, into protocol data units, PDUs, with a packet data convergence protocol, PDCP, 84 according to standard-specification TS25.323, and with radio link control, RLC, protocol 88 according to standard-specification TS25.322, and with a framing protocol, FP, 90 according to standard-specification TS25.427 and TS25.435. The standard-specifications comprise, an MPLS, multi-protocol label switching, standard-specification of the Internet Engineering Task Force for Internet protocol delivery of services. Thus, two-way wireless communications are formatted into voice protocol data units and data protocol data units, both of which are formatted with Internet protocols.

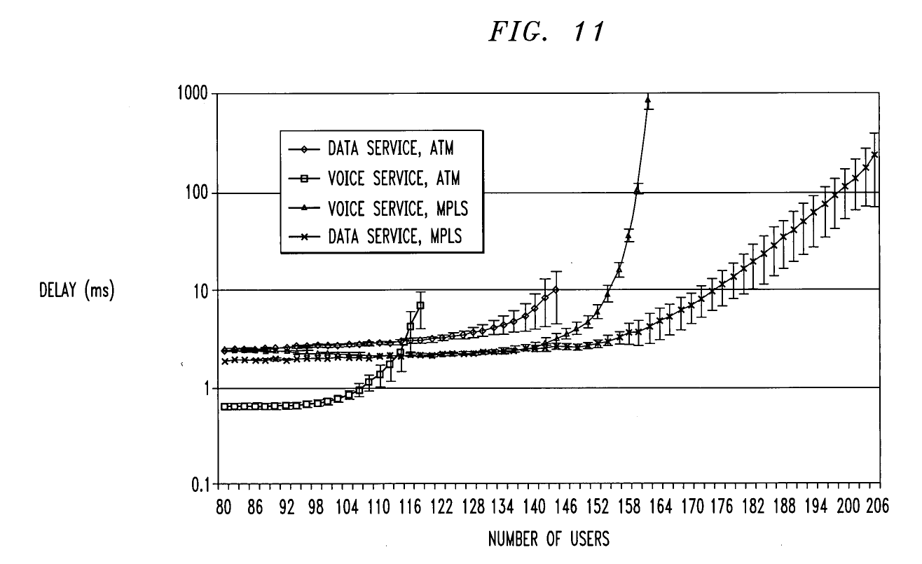

With continued reference to FIG. 8, a segmenter, SEG, 93 of the ASIC 54 segments data protocol data units into segments, comprising data packets. When the data transmission rates are higher than 64 kbps, segmentation of data communications provides opportunities for processing voice packets of voice communication protocol data units, without blockage of such opportunities by the high data rates. For example, the maximum segment length is 350 octets. Examples of data unit segmentation are disclosed in FIG. 10.

FIG. 10 discloses segmentation of a data stream 94 into three, FP protocol formatted, data protocol data units, PDU 96 of 350 octets, PDU 97 of 350 octets, and PDU 98 of a remainder octet duration.

With continued reference to FIG. 8, voice streams from different users of user equipment 22 are intercepted and formatted into voice protocol data units, PDUs, with RLC protocol 88 and FP protocol 90. A multiplexer, MUX, 100 of the ASIC 54 multiplexes the framing protocol, FP, of the voice protocol data units. An example of multiplexed data units of voice streams is disclosed by FIG. 9.

FIG. 9 discloses a process performed by the multiplexer, MUX, 100. FIG. 9 depicts a point to point protocol frame, PPP frame, that depicts two, short octet duration, voice packets comprising segments of FP formatted, voice protocol data units, PDU 104 and PDU 106, which are multiplexed by the MUX 100 to become a single voice packet 108 of an octet duration that is suitable for further processing.

With continued reference to FIG. 8, a voice buffer 112 and a data buffer 110 of the SRAM 56 comprise a memory for storage therein of the respective, voice packets and data packets, PDU 96, PDU 97, PDU 98 and PDU 108. Retrieval from memory storage is on a prioritized first-in, first-out, FIFO, basis. Further, each voice packet, or protocol data unit, PDU 108, is prioritized for processing prior to processing the data packets, or protocol data units, PDU 96, PDU 97 and PDU 98. A scheduler 114 of the ASIC 58 prioritizes the protocol data units and labels them. Further, the scheduler treats all of the protocol data units as packets, and serves as a router that performs packet-switched label-routing to send the packets via a framer 118 to a transmitter Tx. The framer 118 recognizes the packets by their framing protocol, FP. The transmitter Tx transmits the packets along respective external ports, EXP1, 122 for voice and EXP2, 120 for data. From there, the voice packets and data packets transmit along respective, label switched paths, LSPs, 116. The label switched paths, LSPs, 116 comprise the physical layer interconnection 42 between the Pico Node-B base station 40 and the IWG 48 disclosed by FIG. 4. The Pico Node-B base station 40 reformats the Internet formatted packets with UMTS formatting for transport in a direction toward the UMTS protocol communications system, i.e., the elements RNC 46 , or alternatively, the RNC 36 (FIG. 2).

The process and associated elements disclosed by FIG. 8, are duplicated for processing packets, transmitted in a reverse direction from that described, to provide Internet formatted, wireless voice and data streams transmitted to different users of user equipment 22. First, UMTS protocol formatted voice packets and data packets are reformatted with Internet protocols for transport in a direction toward the Pico Node-B base station 40. the reformatted packets are processed according to a duplicate apparatus and process, as described with reference to FIG. 8, for transport to the Pico Node-B base station 40 for wireless transmission to user equipment 22, which includes the process of labeling and routing the packets for transmission along respective label-switched paths to the base station 40.

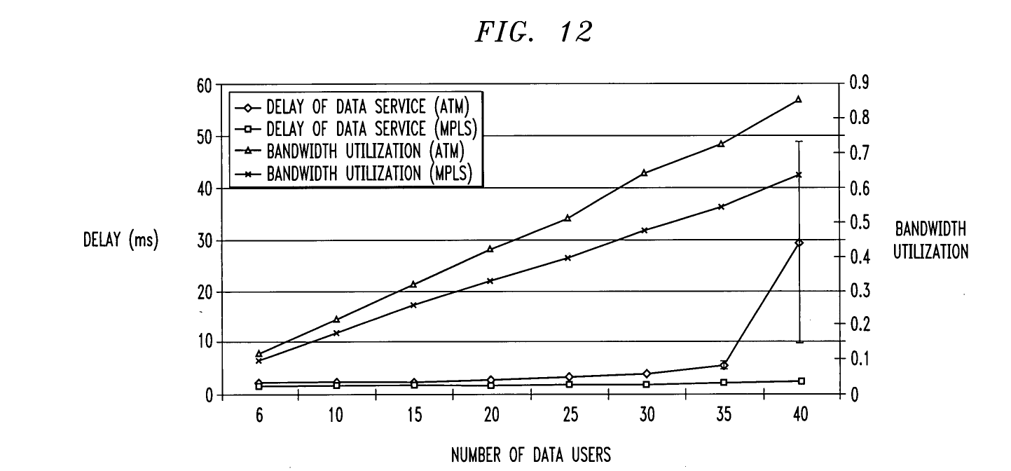

FIG. 11 graphically indicates transport efficiency in terms of signal delays, i.e., signal processing delays, that increase as the number of users increase. For the UMTS communications system disclosed by FIGS. 1 and 2, the transport protocol is ATM. For voice service transported with ATM protocol, the signal delay approaches 10 ms, milliseconds, as the number of users increase to 116. For data service transported with ATM protocol, the delay approaches 10 ms as the number of users increase to 144. By contrast, the MPLS, multi-protocol label switching, disclosed by FIG. 8, has an increased capacity for the number of users before the signal delays approach 10 ms. For example, voice service transported by MPLS allows the number of users to increase to 154 before the delay approaches 10 ms. Similarly, data service transported by MPLS allows the number of user to increase to 174 before the delay approaches 10 ms.

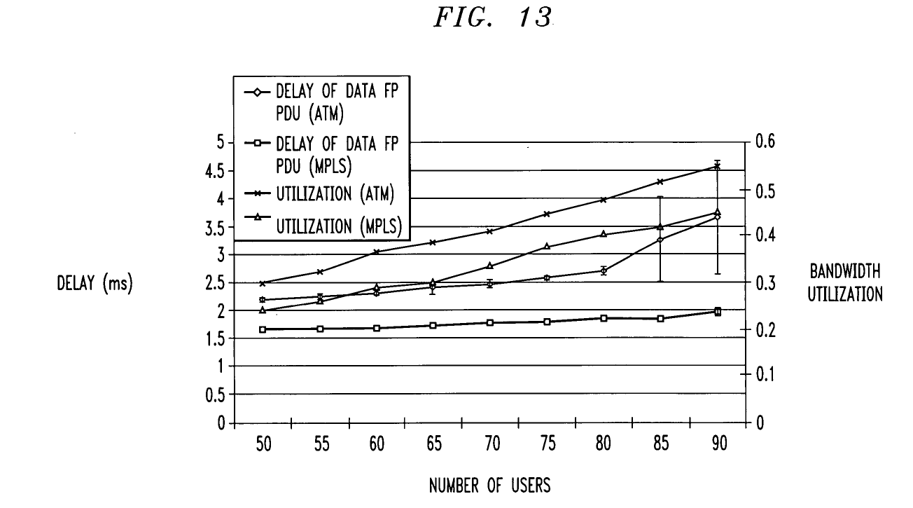

FIG. 12 graphically indicates transport efficiency in terms of signal delay and bandwidth utilization for up to 50 users. Both metrics are larger for signals transported with ATM protocol than for signals transported by MPLS, for the same number of users. Thus, FIG. 12 indicates that signals transported by MPLS experience less delay and consume less bandwidth than do signals transported with ATM protocol.

FIG. 13 graphically indicates transport efficiency in terms of signal delay and bandwidth utilization for 50 users and above. Both metrics are larger for signals transported with ATM protocol than for signals transported by MPLS, for the same number of users. Thus, FIG. 12 indicates that signals transported by MPLS experience less delay and consume less bandwidth than do signals transported with ATM protocol.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A communication system for transporting Internet protocol-formatted communications over a Universal Mobile Telecommunications System (UMTS) wireless communications system, the communication system including a base station and a radio network controller, the communication system further comprising:
an inter-working gateway adapted for interconnection to the radio network controller and the base station, the inter-working gateway being adapted to communicate via Internet transport protocols and UMTS-based transport protocols, the inter-working gateway being further adapted to reformat communications with movable UMTS-based radio-controlled network layer protocols for transport to the radio network controller and to reformat communications with movable Internet radio-controlled network layer protocols for transport to the base station.

2. The communications system as recited in claim 1, wherein the UMTS communications system exists at an installed site.

3. The communications system as recited in claim 1, wherein the inter-working gateway is supplied as pre-installed with the transport protocols.

4. The communications system as recited in claim 1, wherein the inter-working gateway is adapted to receive and download the radio-controlled network layer protocols and the transport protocols from the base station.

5. The communications system as recited in claim 1, wherein the base station and the inter-working gateway are interconnected in a local area network.

6. The communications system as recited in claim 1, further comprising:
an SDRAM memory;
one or more channel elements, each comprising a digital signal processor and associated flash memory and an application specific integrated circuit to manage baseband processing; and
a microprocessor for configuring each channel element, storing user data in the SDRAM memory, and exchanging user data with the digital signal processor.

7. The communications system as recited in claim 1, wherein an interconnection of the inter-working gateway with the base station carries the communications reformatted with the movable UMTS-based radio-controlled network layer protocols in a first direction, and the communications reformatted with the movable Internet radio-controlled network layer protocols in a second direction.

8. The communications system as recited in claim 1, wherein an interconnection of the inter-working gateway with the radio network controller carries the communications reformatted with the movable UMTS-based radio-controlled network layer protocols in a first direction, and the communications reformatted with the movable Internet radio-controlled network layer protocols in a second direction.

9. The communications system as recited in claim 1, wherein
an interconnection of the inter-working gateway with the base station carries the communications reformatted with the movable UMTS-based radio-controlled network layer protocols in a first direction, and the communications reformatted with the movable Internet radio-controlled network layer protocols in a second direction, and
an interconnection of the inter-working gateway with the radio network controller carries the communications reformatted with the movable UMTS-based radio-controlled network layer protocols in a first direction, and the communications formatted with the movable Internet radio-controlled network layer protocols in a second direction.

10. The communications system as recited in claim 1, further comprising:
a Node-B base station adapted for transmitting and receiving cellular telephone communications, the Node-B base station being interconnected with the radio network controller for exchanging wireless cellular telephone communications.

11. The communications system as recited in claim 10, wherein the UMTS communications system exists at an installed site.

12. The communications system as recited in claim 10, wherein the inter-working gateway is supplied as pre-installed with the transport protocols.

13. The communications system as recited in claim 10, wherein the inter-working gateway is adapted to receive and download the radio-controlled network layer protocols and the transport protocols from the base station.

14. The communications system as recited in claim 10, wherein the base station and the inter-working gateway are interconnected in a local area network.

15. The communications system as recited in claim 10, further comprising:
an SDRAM memory;
one or more channel elements each comprising, a digital signal processor and associated flash memory and an application specific integrated circuit to manage baseband processing; and
a microprocessor for configuring each channel element, storing user data in the SDRAM memory, exchanging user data with the digital signal processor, and processing the movable protocols.

16. The communications system as recited in claim 10, wherein an interconnection of the inter-working gateway with the base station carries the communications reformatted with the movable UMTS-based radio-controlled network layer protocols in a first direction, and the communications reformatted with the movable Internet radio-controlled network layer protocols in a second direction.

17. The communications system as recited in claim 10, wherein an interconnection of the inter-working gateway with the radio network controller carries the communications reformatted with the movable UMTS-based radio-controlled network layer protocols in a first direction, and the communications reformatted with the movable Internet radio-controlled network layer protocols in a second direction.

18. The communications system as recited in claim 10, wherein
an interconnection of the inter-working gateway with the base station carries the communications reformatted with the movable UMTS-based radio-controlled network layer protocols in a first direction, and the communications reformatted with the movable Internet radio-controlled network layer protocols in a second direction, and
an interconnection of the inter-working gateway with the radio network controller carries the communications reformatted with the movable UMTS-based radio-controlled network layer protocols in a first direction, and the communications reformatted with the movable Internet radio-controlled network layer protocols in a second direction.

19. An inter-working gateway for wirelessly transporting Internet protocol-formatted communications in a Universal Mobile Telecommunications System (UMTS) communications system, the inter-working gateway comprising:
means for communicating via Internet transport protocols and UMTS-based transport protocols;
means for reformatting communications using movable UMTS-based transport protocols for transport to a radio network controller; and
means for reformatting communications using movable Internet radio-controlled network layer protocols from the radio network controller to the inter-working gateway.

20. A method for transporting Internet protocol-formatted communications over a Universal Mobile Telecommunications System (UMTS) wireless communications system, the method comprising:
segmenting Internet-formatted communications into Internet framing protocol-protocol data units (FP-PDUs);
multiplexing the FP-PDUs over separate label switched paths via multiple protocol label switching (MPLS); and
exchanging the multiplexed FP-PDUs as formatted multiplexed MPLS data segments between a base station and a radio network controller.

21. The method as recited in claim 20, further comprising:
installing radio-controlled network protocols in an inter-working gateway interconnected between the base station and the radio network controller.

22. The method as recited in claim 20, further comprising:
segmenting the Internet-formatted communications into FP-PDUs of 350 octets maximum length.

23. The method as recited in claim 20, further comprising:
formatting the FP-PDUs with UMTS radio-controlled network layer protocols for transport in the UMTS wireless communications system; and
formatting the FP-PDUs with Internet radio-controlled network layer protocols for transmission as wireless Internet communications.

24. The method as recited in claim 21, further comprising:
transporting the FP-PDUs formatted with UMTS radio-controlled network layer protocols from the base station in a first direction; and
transporting the FP-PDUs formatted with Internet radio-controlled network layer protocols in a second direction.

25. A method for transporting Internet protocol-formatted communications over a Universal Mobile Telecommunications System (UMTS) wireless communications system, the UMTS communication system including a base station and a radio network controller, the communication system comprising:
reformatting communications using movable UMTS-based radio-controlled network layer protocols for transport between the base station and the radio network controller; and
reformatting communications using movable Internet radio-controlled network layer protocols for transport between the base station and the radio network controller.
